(19) United States
(12) Patent Application Publication
(10) Pub. No.: US 2009/0090135 A1
(43) Pub. Date: Apr. 9, 2009

(54) METHOD OF MAKING OPTICAL GLASS WINDOWS FREE OF DEFECTS

(75) Inventor: Danh C. Tran, Potomac, MD (US)

Correspondence Address: BROWDY AND NEIMARK, P.L.L.C.;624 NINTH STREET, NW, SUITE 300, WASHINGTON, DC, 20001-5303, US

(73) Assignee: INFRARED FOCAL SYSTEMS, INC., Silver Spring, MD (US)

(21) Appl. No.: 12/240,525

(22) Filed: Sep. 29, 2008

Related U.S. Application Data
(60) Provisional application No. 60/977,523, filed on Oct. 4, 2007.

(51) Int. Cl. C03B 19/02

(52) U.S. Cl. 65/99.1

(57) ABSTRACT

High optical quality glass windows, particularly of low melting and low viscosity glasses and substantially free of defects, particularly adapted for high energy laser applications, are made by stirring the molten glass during cooling without the use of a mechanical stirrer within the glass, by rotating the mold or crucible in which the glass is cooling, using a motion which is not entirely a circular and rotary motion.

### FIELD OF INVENTION

The present invention relates to a process for making optical glass windows free from defects such as bubbles, micro-crystals and index inhomogeneity.

### BACKGROUND OF THE INVENTION

Recently, there has become an escalating need for high optical quality glass windows for high energy laser (HEL) applications. Defects which are detrimental to the performance of HEL windows include bubbles and crystalline particles which give rise to light scattering, and index inhomogeneity which induces optical distortion.

Conventional methods of casting HEL windows use a bottom drain approach^{1, 2}. This approach utilizes a bottom drain furnace/crucible assembly in conjunction with oil or gas cooled brass molds. Batches of glass are loaded in a melt crucible equipped with a lid which has a small opening to allow the insertion of a mechanical stirrer, and a down pipe located at the bottom of the crucible². A cold finger is inserted at the end of the down pipe to ensure that no leakage of glass will occur during the melting process. The melt is refined or homogenized by thorough mixing while in the crucible, using the stirrer which is inserted into the melt. Afterwards, the cold finger is unplugged and the melt is allowed to drain into the brass mold to form a glass window. The window is annealed and then cooled slowly to room temperature. ¹ M. G. Drexhage, L. M. Cook, and T. Margraf: ‘Multikilogram fluoride glass synthesis,’ 5^{th} International Symposium on Halide Glasses (Invited paper), 2, 1988 Shizuoka, Japan, May 29-Jun. 2 (1988).² L. M. Cook, M. J. Liepmann, and A. J. Marker III: ‘Large-scale melting of fluorophosphate optical glasses,’ in Proceedings for the 4^{th} International Symposium on Halide Glasses, Monterey (Calif.), January, 1987.

The bottom drain approach does not apply in a satisfactory way to low melting and low viscosity glasses such as fluoride glasses, fluorophosphates glasses, and oxyfluoride glasses³. As noted in the Cook et al publication (footnote 2 above), this processing approach introduces bubbles and inclusions in the final glass articles. Bubbles are generally formed from turbulent flow of the melt during draining, and inclusions such as micro-crystals originate from deposits of vaporized glass melt. The melt vapor mostly condenses at the spacing between the small opening on the crucible lid and the shaft of the stirrer. Condensation takes place when the hot vapor meets the cooler atmosphere outside the melt crucible. Micro-crystalline inclusions can also nucleate from the surface area of the stirrer itself. ³ Danh Tran: ‘Heavy-metal oxyfluoride glasses for high-energy laser application,’ U.S. patent application No. 60/459,358 (2004).

Omitting the stirrer will help in eliminating particle inclusions. However, the absence of stirring to homogenize the glass melt, especially for a large scale melt preparation, results in index inhomogeneity in the final glass product.

### SUMMARY OF INVENTION

It is an object of the present invention to overcome and/or eliminate problems of the prior art as indicated above.

It is another object of the present invention to provide optical glass windows free or substantially free from defects including bubbles, micro-crystals and index inhomogeneity.

It is a further object of the present invention to provide an improved process for making such improved optical glass windows, especially windows of low melting and low viscosity glasses.

The above objects are achieved by stirring and mixing the molten glass without using a mechanical stirring device within the glass melt.

The above and other objects of the present invention will be more apparent from the following description of preferred embodiments, taken in conjunction with the drawing, wherein:

### BRIEF DESCRIPTION OF THE DRAWING

FIG. 1 is a schematic cross-sectional view of an apparatus for carrying out the present invention; and

FIG. 2 is a schematic representation illustrating suitable types of stirring without employing a mechanical stirring device which contacts the molten glass.

### DESCRIPTION OF EMBODIMENTS

The present invention relates to a novel approach where continuous stirring and mixing of the glass melt can be achieved by rotating the melt crucible, without the use of a mechanical stirrer written the melt, thus avoiding particle inclusions. This novel approach also relates to a method wherein stirring and mixing of the melt can be stopped when the melt becomes viscous enough so that the index homogeneity of the melt, as a result of intense mixing, can be substantially preserved and cannot be disturbed in a meaningful way by thermal convection while the melt is cooling down.

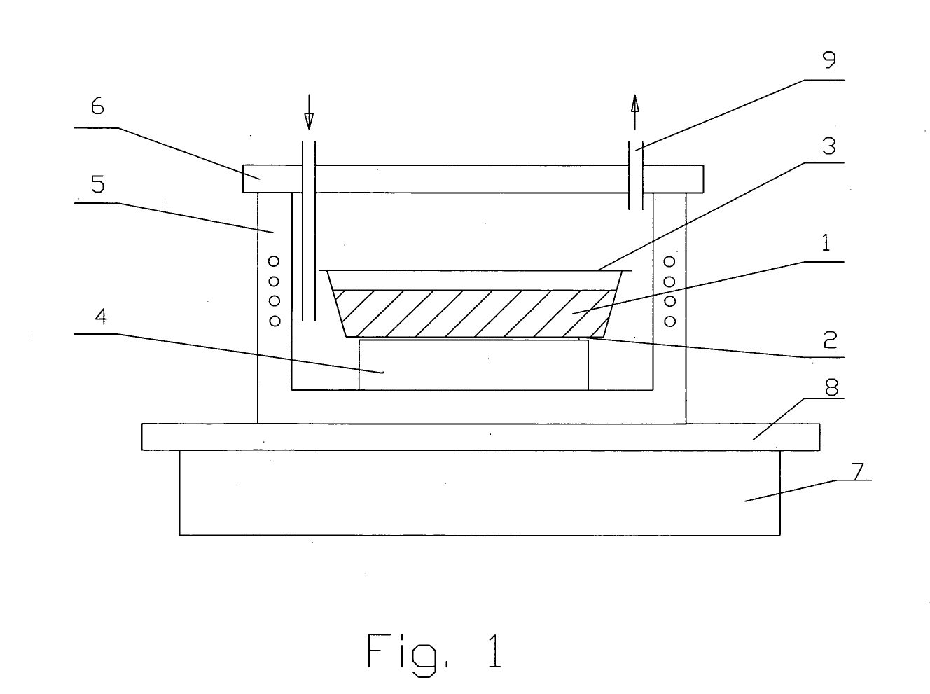

This is shown schematically in FIG. 1 as described below.

A glass batch 1 is charged into a melt crucible 2 equipped with a tight cap 3. The crucible 2 and cap can be made for example of graphite, platinum, or gold. The crucible set-up is placed on a pedestal 4. An electrical furnace 5 with a tight lid 6 is desirably used in the melting process. The furnace assembly is positioned on top of a bottom support 7 equipped with a rotating plate 8. Inert gas is flown in and out of the furnace chamber through tubes 9 to keep the melt atmosphere free of particulate impurities. During the glass melting process, a rotational motion by rotation of the plate 8 is applied to the overall melt set-up.

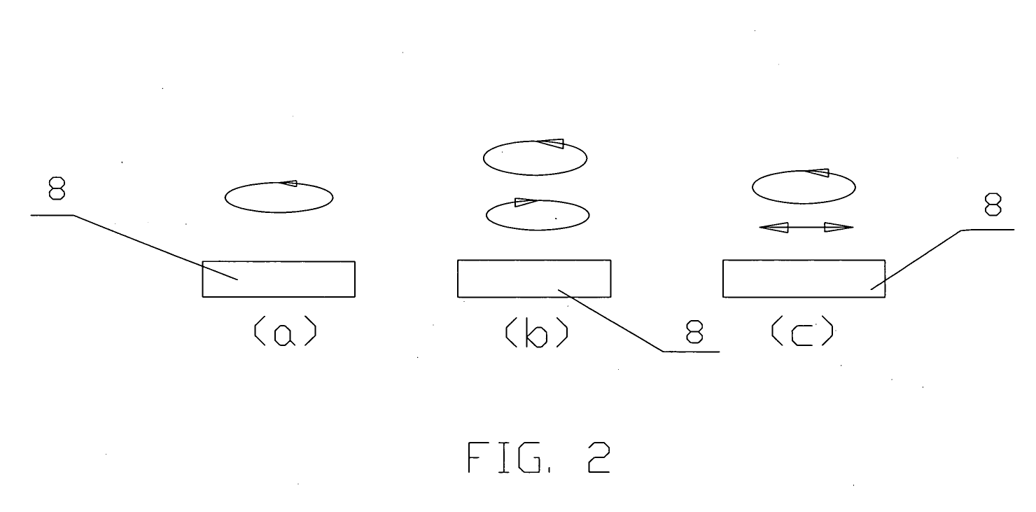

Rotation of the melt can be stopped when the melt becomes sufficiently viscous, when a viscosity of around 60 poises or higher is achieved. It is of most importance that the rotation does not follow a circular path. If a circular path of the melt is carried out, localized index inhomogeneity can be observed at the middle of the glass window. It is preferable that the rotation follows a path of an orbit or orbital path as shown in FIG. 2(a), or that the rotation follows a dual orbital path in which two orbital paths move simultaneously but in the opposite direction with respect to each other as shown in FIG. 2(b), or that the rotation follows an orbital path and a reciprocal (back and forth) path simultaneously as shown in FIG. 2(c). Using these rotational melting approaches, bubbles, index inhomogeneity and inclusions can be completely or substantially completely avoided.

After melting and refining, the melt is annealed at about the glass transition temperature (T_{g}) for the particular glass in question to remove thermal stress, and the glass is then cooled to room temperature.

In the above description the crucible 2 also serves as a mold for the window. Alternatively, the glass can be initially cast in the crucible, and then transferred to a mold which is rotated as described above, and in which the molten glass is cooled, annealed, and then cooled to room temperature.

### EXAMPLES

### Example 1

The molar composition of a low-temperature and low-viscosity glass used was 5.5 Al(PO₃)₃-53.5 RF₂-20 AlF₃-16 R′F-3Al₂O₃, and 2 SiO₂, where R is selected from the alkaline-earth metals Mg, Ca, Sr, and Ba, and R′ represents the alkali metals Li, Na, K, and Cs. A glass batch of 120 g was melted in a round platinum crucible sealed with a tight platinum cap. The crucible was placed inside a furnace positioned on top of a Thermolyne Big Bill orbital mixer having an orbital diameter of 0.5 in. Nitrogen was introduced inside the furnace chamber. The melt was heated to 950° C. at which temperature the mixer was turned on with an orbital mixing speed of 200 rpm. The glass was melted at 950° C. for 2 hrs, refined at 850° C. for 1 hr, annealed at around the glass transition temperature of 375° C. for 30 min, and then cooled to room temperature. Orbital mixing was stopped when the temperature reached 375° C., at which temperature the melt had already solidified.

The resulting glass window, 2.0 in diam. by 0.75 in thick, was examined under a high magnification microscope. No bubbles, micro-crystals, or inclusions were observed. The index homogeneity was also investigated using a Zygo interferometer. Distortion due to index inhomogeneity was measured to be as low as 80 nm peak to valley throughout the window.

### Example 2

120 g of glass of similar composition as in Example 1 was melted in a round platinum crucible sealed with a tight platinum cap. The crucible was placed inside a furnace positioned on top of a Thermolyne Big Bill orbital mixer having an orbital diameter of 0.5 in. Nitrogen was introduced inside the furnace chamber. The Thermolyne mixer was placed on top of a second orbital mixer, Model G2 from New Brunswick Scientific, which also had a 0.5 in. orbital diameter. The melt was heated to 950° C. at which temperature the two mixers were turned on at the same time. The Thermolyne mixer followed an orbital speed of 144 rpm clockwise while the New Brunswick mixer turned counter clockwise at 144 rpm.

The glass was melted at 950° C. for 2 hrs, refined at 850° C. for 1 hr, annealed at around the glass transition temperature of 375° C. for 30 min, and then cooled to room temperature. Orbital mixing was stopped when the temperature reached 375° C. At this temperature the melt had already solidified.

The resulting glass window, 2.0 in diam. by 0.75 in thick, was examined under a high magnification microscope. No bubbles, micro-crystals, or inclusions were observed. The index homogeneity was also investigated using a Zygo interferometer. Distortion due to index inhomogeneity was measured to be as low as 85 nm peak to valley throughout the window.

### Example 3

120 g of glass of similar composition as in Example 1 was melted in a round platinum crucible sealed with a tight platinum cap. The crucible was placed inside a furnace positioned on top of a Thermolyne orbital mixer having an orbital diameter of 0.5 in. Nitrogen was introduced inside the furnace chamber. The Thermolyne mixer was placed on top of an Eberbach 5900 reciprocal mixer which generates a back and forth motion with a stroke of 1⅛ in. per cycle. The melt was heated to 950° C. at which temperature the two mixers were turned on at the same time. The Thermolyne mixer followed an orbital speed of 100 rpm clockwise while the Ebernbach mixer followed a back and forth motion at a rate of 100 cycles per min. The glass was melted at 950° C. for 2 hrs, refined at 850° C. for 1 hr, annealed at around the glass transition temperature of 375° C. for 30 min., and then cooled to room temperature.

Orbital mixing and reciprocal mixing were stopped when the temperature reached 375° C., at which temperature the melt had already solidified.

The resulting glass window, 2.0 in diam. by 0.75 in thick, was examined under a high magnification microscope. No bubbles, micro-crystals, or inclusions were observed. The index homogeneity was also investigated using a Zygo interferometer. Distortion due to index inhomogeneity was measured to be as low as 100 nm peak to valley throughout the window.

### Example 4

About 1,300 g of glass of similar composition as in Example 1 were melted in a round platinum crucible sealed with a tight platinum cap. The crucible was placed inside a furnace positioned on top of a Model G10 New Brunswick Scientific orbital mixer having an orbital diameter of 1.0 in. Nitrogen was introduced inside the furnace chamber. The melt was heated to 950° C. at which temperature the mixer was turned on with an orbital mixing speed of 90 rpm. The glass was melted at 950° C. for 2 hrs, refined at 850° C. for 2 hr, annealed at around 375° C. for 2 hrs, and then cooled to room temperature. Orbital mixing was stopped when the temperature reached about 600° C. where the melt viscosity was 60 poises.

The resulting glass window, 6.0 in diam. by 1.0 in thick, was examined under a high magnification microscope by scanning throughout its bulk volume. No bubbles, micro-crystals, or inclusions were observed. The index homogeneity was also investigated using a Zygo interferometer. Distortion due to index inhomogeneity was measured to be as low as 94 nm peak to valley throughout the window.

### Example 5

Around 25,000 g of glass of similar composition as in Example 1 were melted in a round platinum crucible sealed with a tight platinum cap. The crucible was placed inside a furnace positioned on top of a Model G10 New Brunswick Scientific orbital mixer having an orbital diameter of 1.0 in. Nitrogen was introduced inside the furnace chamber. The melt was heated to 950° C. at which temperature the mixer was turned on with an orbital mixing speed of 47 rpm. The glass was melted at 950° C. for 3 hrs, refined at 850° C. for 4 hrs annealed at around 375° C. for 4.5 hrs, and then cooled to room temperature. Orbital mixing was stopped when the temperature reached 375° C.

The resulting glass window, 16.5 in diam. by 2.0 in thick, was examined for bubbles, micro-crystals, and inclusions by scanning a powerful beam of white light throughout its bulk volume. No defects were observed. The index homogeneity was also investigated using a Zygo interferometer. Distortion due to index inhomogeneity was measured to be as low as 40 nm peak to valley throughout the window.

The forgoing description of specific embodiments reveals the general nature of the invention so that others can, by applying current knowledge, readily modify and/or adapt for various applications such embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not limitation.

What is claimed is:

1. A method of making a high optical quality glass window substantially free of defects, optionally adapted for high energy laser applications, comprising
melting a glass composition suitable for making an optical glass window, and forming the molten glass to a window shape, and cooling the molten glass,
wherein the window is formed in a mold or crucible to which motion is applied until at least, during cooling, the molten glass has reached a viscosity of about 60 poises or more,
wherein said motion is not entirely a circular, rotary motion.

2. The method of claim 1, wherein said motion is rotational and non-circular.

3. The method of claim 1, wherein said motion follows at least one non-circular, orbital path.

4. The method according to claim 3, wherein the rotation follows a dual orbital path.

5. The method of claim 1, wherein said motion comprises one rotational path and one reciprocal path superimposed one upon the other.

6. The method in accordance with claim 1, wherein the glass is a low melting and low viscosity glass.

7. The method of claim 6, wherein the low melting and low viscosity glass is a fluoride glass, a fluorophosphate glass or an oxyfluoride glass.

8. The method in accordance with claim 2, wherein the glass is a low melting and low viscosity glass.

9. The method of claim 8, wherein the low melting and low viscosity glass is a fluoride glass, a fluorophosphate glass or an oxyfluoride glass.

10. The method in accordance with claim 3, wherein the glass is a low melting and low viscosity glass.

11. The method of claim 10, wherein the low melting and low viscosity glass is a fluoride glass, a fluorophosphate glass or an oxyfluoride glass.

12. The method in accordance with claim 4, wherein the glass is a low melting and low viscosity glass.

13. The method of claim 12, wherein the low melting and low viscosity glass is a fluoride glass, a fluorophosphate glass or an oxyfluoride glass.

14. The method in accordance with claim 5, wherein the glass is a low melting and low viscosity glass.

15. The method of claim 14, wherein the low melting and low viscosity glass is a fluoride glass, a fluorophosphate glass or an oxyfluoride glass.
